(19) United States
(12) Patent Application Publication
(10) Pub. No.: US 2024/0410193 A1
(43) Pub. Date: Dec. 12, 2024

(54) CHLORINE TABLET DISPENSER

(71) Applicant: Michael E. Pugh, Cypress, TX (US)

(72) Inventor: Michael E. Pugh, Cypress, TX (US)

(21) Appl. No.: 18/207,848

(22) Filed: Jun. 9, 2023

(51) Int. Cl. E04H 4/12

(52) U.S. Cl. CPC E04H 4/1281

(57) ABSTRACT

A chlorine tablet dispenser may include a cylindrical body member including a plurality of fluid passageways extending from an outer surface of the cylindrical body member to an inner bore of the cylindrical body member. The outer diameter of the cylindrical body member may be sized to fit within a cylindrical housing of a chlorinator tower. The inner bore of the cylindrical body member may be sized to receive a series of stacked chlorine tablets. The cylindrical body member may include a floor, which may be spaced apart from a lower end of the cylindrical body member, and may also include a plurality of fluid passageways. The cylindrical body member may include a longitudinal slot extending from the lower end of the cylindrical body member toward an upper end of the cylindrical body member. The cylindrical body member may include one or more grasping apertures.

### BACKGROUND OF THE INVENTIONS

### 1. Field of the Inventions

The present inventions generally pertain to swimming pool equipment, and more particularly to devices for dispensing chlorine tablets.

### 2. Description of the Related Art

It is known that a basic part of maintaining a swimming pool is introducing chlorine into the swimming pool water. Chlorine for this purpose typically comes in tablet form, such as in the form of circular pucks around the size and shape of a hockey puck. It is standard for inground swimming pool equipment to include a chlorinator tower for receiving and disbursing chlorine tablets/pucks into the pool water. The chlorinator tower is an integral part of the process equipment for pool water maintenance. One problem that presently exists relates to the process of placing the chlorine tablets into the chlorinator tower. This is done by unscrewing a lid at the top of the chlorinator tower and then inserting the chlorine tablets down into the interior of the chlorinator tower. It is not uncommon for the person inserting the tablets to have hands of a size that render it difficult, if not impossible, for the person to lower the tablets all the way down into the bottom of the chlorinator tower. This leaves as the only option dropping the tablets down into the chlorinator tower. However, what often happens when this is done is that the tablet will end up resting on an edge and standing up vertically, or at an incline, as opposed to laying down flat as desired. This can be difficult to correct if the person inserting the tablets cannot reach down into the chlorinator tower to reach the tablet that is incorrectly positioned. In addition to this problem, many people prefer not to touch chlorine tablets for fear of chemical burns to the skin or damaging to clothes. Lastly, a significant safety hazard exists when dropping/introducing a chlorine puck into the chlorinator tower when residual water splashes back into the face and eye area of the person handling the chlorine pucks.

As will become apparent from the following descriptions and discussion, the present inventions encompass novel and unique chlorine tablet devices and methods for placing chlorine tablets into a chlorinator tower in a way that overcomes one or more of the above-described problems.

### SUMMARY OF THE INVENTIONS

In one aspect, the present inventions relate to a chlorine tablet dispenser including a cylindrical body member having an upper end, a lower end, and an inner bore; the cylindrical body member further including a plurality of fluid passageways extending from an outer surface of the cylindrical body member to the inner bore of the cylindrical body member; the outer diameter of the cylindrical body member being sized to fit within a cylindrical housing of a chlorinator tower; and the inner bore of the cylindrical body member being sized to receive a series of stacked chlorine tablets. Another feature of this aspect of the present inventions may be that the cylindrical housing further includes a longitudinal slot extending from a lower end of the cylindrical housing toward an upper end of the cylindrical housing. Another feature of this aspect of the present inventions may be that the longitudinal slot includes a top edge, the top edge being spaced apart from the upper end of the cylindrical body member. Another feature of this aspect of the present inventions may be that the top edge of the longitudinal slot is semi-circular in shape. Another feature of this aspect of the present inventions may be that the dispenser may further include a floor connected to the cylindrical body member. Another feature of this aspect of the present inventions may be that the floor is spaced apart from the lower end of the cylindrical body member. Another feature of this aspect of the present inventions may be that the floor lies in a plane that is generally parallel to the lower end of the cylindrical body member. Another feature of this aspect of the present inventions may be that the floor includes a plurality of fluid passageways. Another feature of this aspect of the present inventions may be that the floor includes a notch aligned with a longitudinal slot that extends from the lower end of the cylindrical body member toward the upper end of the cylindrical body member. Another feature of this aspect of the present inventions may be that the cylindrical body member further includes a left grasping aperture and a right grasping aperture.

In another aspect, the present inventions may include a chlorine tablet dispenser comprising: a cylindrical body member having an upper end, a lower end, and an inner bore; the cylindrical body member further including a plurality of fluid passageways extending from an outer surface of the cylindrical body member to the inner bore of the cylindrical body member; and the cylindrical housing further including a longitudinal slot extending from a lower end of the cylindrical housing toward an upper end of the cylindrical housing, the longitudinal slot including a top edge, the top edge being spaced apart from the upper end of the cylindrical body member. Another feature of this aspect of the present inventions may be that the top edge of the longitudinal slot is semi-circular in shape. Another feature of this aspect of the present inventions may be that the dispenser may further include a floor connected to the cylindrical body member. Another feature of this aspect of the present inventions may be that the floor is spaced apart from the lower end of the cylindrical body member and is located in a plane that is generally parallel to the lower end of the cylindrical body member. Another feature of this aspect of the present inventions may be that the floor includes a plurality of fluid passageways. Another feature of this aspect of the present inventions may be that the floor includes a notch aligned with the longitudinal slot. Another feature of this aspect of the present inventions may be that the cylindrical body member further includes a left grasping aperture and a right grasping aperture.

In another aspect, the present inventions may include a chlorine tablet dispenser comprising: a cylindrical body member having an upper end, a lower end, and an inner bore; the cylindrical body member further including a plurality of fluid passageways extending from an outer surface of the cylindrical body member to the inner bore of the cylindrical body member; the cylindrical housing further including a longitudinal slot extending from a lower end of the cylindrical housing toward an upper end of the cylindrical housing, the longitudinal slot including a top edge; and a floor connected to the cylindrical body member. Another feature of this aspect of the present inventions may be that the floor is spaced apart from the lower end of the cylindrical body member, includes a plurality of fluid passageways, and is located in a plane that is generally parallel to the lower end of the cylindrical body member. Another feature of this aspect of the present inventions may be that the floor includes a notch aligned with the longitudinal slot.

Other features, aspects and advantages of the present inventions will become apparent from the following discussion and detailed description.

### BRIEF DESCRIPTION OF THE DRAWINGS

FIG. 1 is a perspective view of a chlorinator tower with a specific embodiment of a chlorine tablet dispenser constructed in accordance with one aspect of the present inventions partially positioned therein.

FIG. 2 is a front view of a specific embodiment of a chlorine tablet dispenser with a stack of chlorine tablets to be inserted into the chlorine tablet dispenser positioned to the right of the chlorine tablet dispenser.

FIG. 3 is a top view of the chlorine tablet dispenser shown in FIG. 2.

FIG. 4 is a side view of the chlorine tablet dispenser shown in FIG. 2.

FIG. 5 is a perspective view of the chlorine tablet dispenser shown in FIGS. 2-4.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

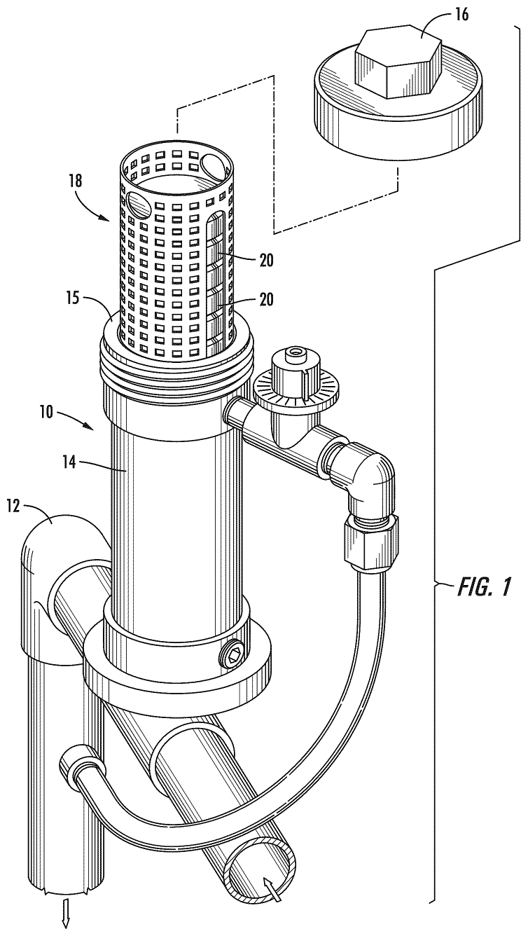

Referring now to the drawings, and referring initially to FIG. 1, there is shown a perspective view of a chlorinator tower 10 in communication with a conduit 12 through which water is circulated in connection with a swimming pool (not shown). In a specific embodiment, the chlorinator tower 10 may include a cylindrical housing 14 and a lid 16 adapted for threadable attachment to an upper end 15 of the cylindrical housing 14. A specific embodiment of a chlorine tablet dispenser 18 is shown partially disposed within the cylindrical housing 14 of the chlorinator tower 10, with the lid 16 separated from the cylindrical housing 14 and shown above the chlorine tablet dispenser 18. In a specific embodiment, the chlorine tablet dispenser 18 may have an outer diameter sized so as to closely fit within the cylindrical housing 14 of the chlorinator tower 10. The chlorine tablet dispenser 18 is shown with a plurality of chlorine tablets 20 disposed within the chlorine tablet dispenser 18. The chlorine tablet dispenser 18 is loaded with chlorine tablets 20 prior to being inserted into the chlorinator tower 10.

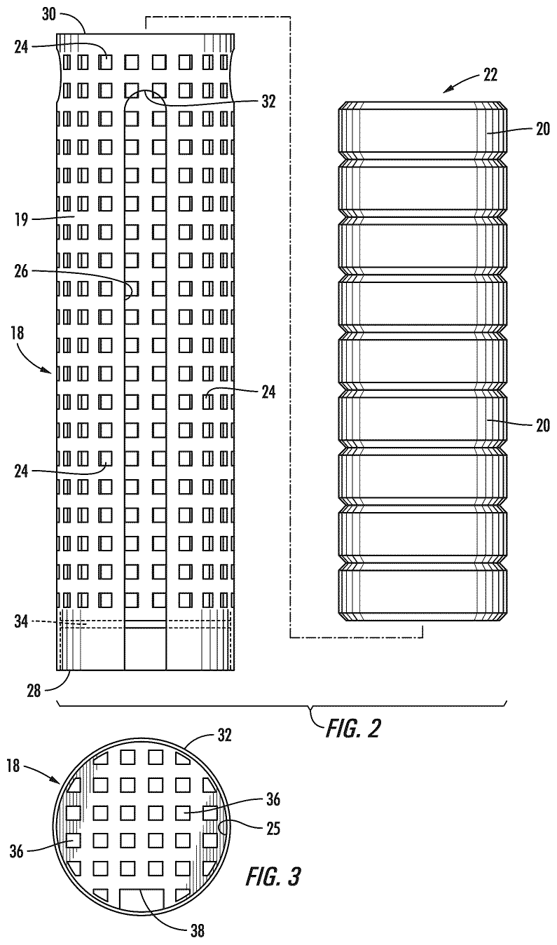

FIG. 2 illustrates a front view of the chlorine tablet dispenser 18 shown in FIGS. 1 and 1A. Further, in FIG. 2, a stack 22 of chlorine tablets 20 is shown to the right of the chlorine tablet dispenser 18 before being placed therein. It can be seen in FIGS. 2 and 3 that the chlorine tablet dispenser 18 may include a cylindrical body member 19 including a plurality of fluid passageways 24 and an inner bore 25. When the chlorine tablet dispenser 18 is disposed within the chlorinator tower 10, these fluid passageways 24 function to facilitate flow of swimming pool water within the chlorinator tower 10 and around and across the chlorine tablets 20 held within the chlorine tablet dispenser 18.

In a specific embodiment, the cylindrical body member 19 of the chlorine tablet dispenser 18 may further include a longitudinal slot 26 extending from a lower end 28 of the cylindrical body member 19 toward an upper end 30 of the cylindrical body member 19. In a specific embodiment, the longitudinal slot 26 may be disposed in generally parallel relationship with a side wall 32 defined by the cylindrical body member 19 and/or with a central longitudinal axis of the cylindrical body member 19. In a specific embodiment, the longitudinal slot 26 may be disposed in generally perpendicular relationship with the lower end 28 of the cylindrical body member 19. The longitudinal slot 26 may have a width sufficiently wide (such as in the range from ½ inches to 1 inch, for example) to allow for a person's finger to reach through the side wall 32 of the cylindrical body member 19 to manipulate the chlorine tablets 20 as they are being lowered into the chlorine tablet dispenser 18. In a specific embodiment, a top edge 32 of the longitudinal slot 26 may be spaced apart from the upper end 30 of the cylindrical body member 19. In a specific embodiment, the top edge 32 of the longitudinal slot 26 may be semi-circular in shape.

In a specific embodiment, the chlorine tablet dispenser 18 may include a floor 34. In a specific embodiment, the floor 34 may be connected to the cylindrical body member 19. In a specific embodiment, the floor 34 may be located in a plane generally parallel to the lower end 28 of the cylindrical body member 19. In a specific embodiment, the floor 34 may be spaced apart from the lower end 28 of the cylindrical body member 19. In a specific embodiment, the floor 34 may include a plurality of flow passageways 36 to further facilitate circulation of swimming pool water around and across the chlorine tablets 20. It is noted that spacing the floor 34 apart from the lower end 28 of the cylindrical body member 19 will further facilitate circulation of swimming pool water through the passageways 36 and across and around the chlorine tablets 20. In a specific embodiment, the fluid passageways 24 (discussed above) and 34 may be of any desired shape, such as square, round, trapezoidal, etc., for example. As shown in FIG. 3, which is a top view of the chlorine tablet dispenser 18 shown in FIG. 2, the floor 34 may include a notch 38 that may be aligned with the longitudinal slot 26.

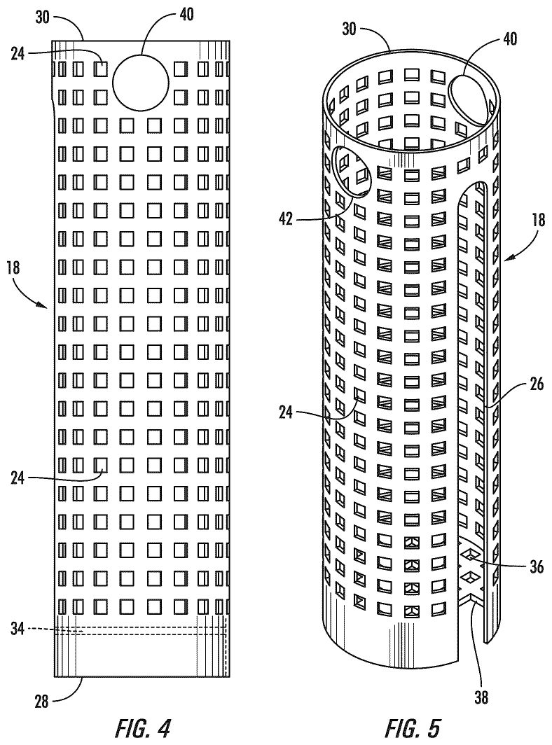

Referring now to FIG. 4, which is a side view of the chlorine tablet dispenser 18 shown in FIGS. 1-3, it can be seen that, in a specific embodiment, the chlorine tablet dispenser 18 may include a right grasping aperture 40. In a specific embodiment, the right grasping aperture 40 may be circular in shape. As shown in FIG. 5, which is a perspective view of the chlorine tablet dispenser 18 shown in FIGS. 1-4, it can be seen that, in a specific embodiment, the chlorine tablet dispenser 18 may include a left grasping aperture 42. The left grasping aperture 42 may also be round in shape. In a specific embodiment, the left and right grasping apertures 40 and 42 may be disposed directly across from each other on opposite sides of the cylindrical body member 19. In a specific embodiment, the left and right grasping members 40 and 42 may be positioned adjacent the upper end 30 of the cylindrical body member 19. The left and right grasping members 40 and 42 may function to provide a place for a person to grasp the chlorine tablet dispenser 18 in order to lower it into the chlorinator tower 10 and to remove it from the chlorinator tower 10. In a specific embodiment, each of the left and right grasping apertures 40 and 42 may be round and have a diameter in the range of ¾ inches to 1¼ inches, for example.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims. Accordingly, the inventions are therefore to be limited only by the scope of the appended claims.

1. A chlorine tablet dispenser comprising:
a cylindrical body member having an upper end, a lower end, and an inner bore;
the cylindrical body member further including a plurality of fluid passageways extending from an outer surface of the cylindrical body member to the inner bore of the cylindrical body member;
the outer diameter of the cylindrical body member being sized to fit within a cylindrical housing of a chlorinator tower; and
the inner bore of the cylindrical body member being sized to receive a series of stacked chlorine tablets.

2. The chlorine tablet dispenser of claim 1, wherein the cylindrical housing further includes a longitudinal slot extending from a lower end of the cylindrical housing toward an upper end of the cylindrical housing.

3. The chlorine tablet dispenser of claim 2, wherein the longitudinal slot includes a top edge, the top edge being spaced apart from the upper end of the cylindrical body member.

4. The chlorine tablet dispenser of claim 3, wherein the top edge of the longitudinal slot is semi-circular in shape.

5. The chlorine tablet dispenser of claim 1, further including a floor connected to the cylindrical body member.

6. The chlorine tablet dispenser of claim 5, wherein the floor is spaced apart from the lower end of the cylindrical body member.

7. The chlorine tablet dispenser of claim 5, wherein the floor lies in a plane that is generally parallel to the lower end of the cylindrical body member.

8. The chlorine tablet dispenser of claim 5, wherein the floor includes a plurality of fluid passageways.

9. The chlorine tablet dispenser of claim 5, wherein the floor includes a notch aligned with a longitudinal slot that extends from the lower end of the cylindrical body member toward the upper end of the cylindrical body member.

10. The chlorine tablet dispenser of claim 1, wherein the cylindrical body member further includes a left grasping aperture and a right grasping aperture.

11. A chlorine tablet dispenser comprising:
a cylindrical body member having an upper end, a lower end, and an inner bore;
the cylindrical body member further including a plurality of fluid passageways extending from an outer surface of the cylindrical body member to the inner bore of the cylindrical body member; and
the cylindrical housing further including a longitudinal slot extending from a lower end of the cylindrical housing toward an upper end of the cylindrical housing, the longitudinal slot including a top edge, the top edge being spaced apart from the upper end of the cylindrical body member.

12. The chlorine tablet dispenser of claim 11, wherein the top edge of the longitudinal slot is semi-circular in shape.

13. The chlorine tablet dispenser of claim 11, further including a floor connected to the cylindrical body member.

14. The chlorine tablet dispenser of claim 13, wherein the floor is spaced apart from the lower end of the cylindrical body member and is located in a plane that is generally parallel to the lower end of the cylindrical body member.

15. The chlorine tablet dispenser of claim 13, wherein the floor includes a plurality of fluid passageways.

16. The chlorine tablet dispenser of claim 13, wherein the floor includes a notch aligned with the longitudinal slot.

17. The chlorine tablet dispenser of claim 11, wherein the cylindrical body member further includes a left grasping aperture and a right grasping aperture.

18. A chlorine tablet dispenser comprising:
a cylindrical body member having an upper end, a lower end, and an inner bore;
the cylindrical body member further including a plurality of fluid passageways extending from an outer surface of the cylindrical body member to the inner bore of the cylindrical body member;
the cylindrical housing further including a longitudinal slot extending from a lower end of the cylindrical housing toward an upper end of the cylindrical housing, the longitudinal slot including a top edge; and
a floor connected to the cylindrical body member.

19. The chlorine tablet dispenser of claim 18, wherein the floor is spaced apart from the lower end of the cylindrical body member, includes a plurality of fluid passageways, and is located in a plane that is generally parallel to the lower end of the cylindrical body member.

20. The chlorine tablet dispenser of claim 18, wherein the floor includes a notch aligned with the longitudinal slot.
